(19) United States
(12) Patent Application Publication
(10) Pub. No.: US 2017/0077868 A1
(43) Pub. Date: Mar. 16, 2017

(54) POWER POINT TRACKING VIA SOLAR-BATTERY-CONVERTER

(71) Applicant: PHILIPS LIGHTING HOLDING B.V., Eindhoven (NL)

(72) Inventors: PRIYA RANJAN MISHRA, EINDHOVEN (NL); RAKESHBABU PANGULOORI, EINDHOVEN (NL); SREENIVASA CHARY BANALA, EINDHOVEN (NL)

(73) Assignee: PHILIPS LIGHTING HOLDING B.V., Eindhoven (NL)

(21) Appl. No.: 15/120,108

(22) PCT Filed: Feb. 9, 2015
(86) PCT No.: PCT/EP2015/052567

§ 371 Date: Aug. 18, 2016

(30) Foreign Application Priority Data
Feb. 21, 2014 (EP) 14156195.1

(51) Int. Cl. H02S 40/32; H02S 40/38; H02J 7/35; H02J 3/38

(52) U.S. Cl. CPC H02S 40/32; H02J 3/385; H02S 40/38; H02J 7/35

(57) ABSTRACT

Controllers (1) control converters (2) that convert first power from solar arrangements (3) into second power for battery arrangements (4). Said control comprises, in response to detections of values of current signals flowing through the battery arrangements (4), adjustments of impedances of the converters (2) for maximizing the current signals. A kind of maximum power point tracking is performed, without many multiplications of voltage signals and current signals provided by the solar arrangements (3) needing to be performed. Said adjustments may comprise adjustments in first directions in case the values of the current signals flowing through the battery arrangements (4) show increases and adjustments in different second directions in case the values of the current signals flowing through the battery arrangements (4) show decreases. Said adjustments may comprise adaptations of pulse width modulations of the converters (2).

### FIELD OF THE INVENTION

The invention relates to a controller for controlling a converter configured to convert first power from a solar arrangement into second power for a battery arrangement.

The invention further relates to a converter for converting first power from a solar arrangement into second power for a battery arrangement, to a solar arrangement comprising the converter, to a battery arrangement comprising the converter, to a method for controlling the converter, to a computer program product and to a medium.

Examples of such a converter are buck-converters, boost-converters, buck-boost-converters, DC-to-DC-converters and inverters.

### BACKGROUND OF THE INVENTION

The article “A Novel Maximum Power Point Tracking Method for PV Module Integrated Converter” by Hirotaka Koizumi and Kosuke Kurokawa, the Department of Electrical and Electronic Engineering, Tokyo University of Agriculture and Technology 2-24-16 Naka-cho, Koganei, Tokyo, 184-8588, Japan, discloses a converter for converting first power from a solar arrangement into second power for a load arrangement.

To perform maximum power point tracking, a voltage signal provided by the solar arrangement and a current signal flowing through the solar arrangement are to be multiplied. Such multiplications of signals are considered to be disadvantageously complex and time-consuming and should preferably be avoided as much as possible.

DE 196 18 882 A1 discloses an arrangement for powering a consumer through a solar generator.

U.S. Pat. No. 5,493,204 discloses a negative impedance peak power tracker.

### SUMMARY OF THE INVENTION

It is an object of the invention to provide a controller for advantageously controlling a converter configured to convert first power from a solar arrangement into second power for a battery arrangement. It is a further object of the invention to provide a converter, a solar arrangement, a battery arrangement, a method, a computer program product and a medium.

According to a first aspect, a controller is provided for controlling a converter configured to convert first power from a solar arrangement into second power for a battery arrangement, said controlling comprising, in response to detections of values of a current signal flowing through the battery arrangement, adjustments of an impedance of the converter for maximizing the current signal.

A controller controls a converter for converting first (solar) power from a solar arrangement into second (charging) power for a battery arrangement. Thereto, values of a current signal flowing through the battery arrangement are detected and used for adjusting an impedance of the converter such that the current signal flowing through the battery arrangement is maximized. As a result, (a kind of) maximum power point tracking is performed, without a voltage signal provided by the solar arrangement and a current signal flowing through the solar arrangement needing to be multiplied. This is a great improvement.

A solar arrangement coupled to an input of a converter and a battery arrangement coupled to an output of the converter experience an impedance present between the input and the output of the converter. By adjusting a value of this impedance, a power point of the solar arrangement can be controlled.

A solar arrangement comprises for example one or more photovoltaic panels or one or more solar panels of whatever kind and—for two or more—in whatever combination. A battery arrangement comprises for example one or more batteries of whatever kind and—for two or more—in whatever combination.

An embodiment of the controller is defined by the controller being configured to perform maximum power point tracking without multiplying a voltage signal provided by the solar arrangement and a current signal flowing through the solar arrangement. The reason that multiplications of a voltage signal provided by the solar arrangement and a current signal flowing through the solar arrangement no longer need to be made is as follows. The first (solar) power will be relatively proportional to the second (charging) power, with the amount of proportionality being defined by controlling the converter. Therefore, alternatively to a determination of a product of the voltage signal and the current signal at the side of the solar arrangement, a product of a voltage signal and a current signal at the side of the battery arrangement can be determined. Owing to the fact that a voltage signal present across the battery arrangement will be relatively stable, especially during a relatively short amount of time, only values of a current signal flowing through the battery arrangement need to be detected, and these values can be used for adjusting an impedance of the converter to maximize the current signal flowing through the battery arrangement.

An embodiment of the controller is defined by said adjustments comprising an adjustment in a first direction in case the values of the current signal flowing through the battery arrangement show an increase and comprising an adjustment in a second direction in case the values of the current signal flowing through the battery arrangement show a decrease, said first and second directions being different directions. An adjustment in a first direction may be a decrease (increase) of an impedance of the converter, and an adjustment in a second direction may then be an increase (decrease) of the impedance of the converter. Values of a current signal flowing through the battery arrangement are values at different moments in time, such as for example two subsequent values or two non-subsequent values, and such as for example a present value and a past value etc. The different moments in time may for example be sample moments in time, and the values may then be sample values. Between these values at the different moments in time, a voltage signal present across the battery arrangement will have a relatively stable value.

An embodiment of the controller is defined by the adjustment in the first direction being a decrease of the impedance of the converter, and the adjustment in the second direction being an increase of the impedance of the converter, or vice versa.

An embodiment of the controller is defined by said adjustments comprising adaptations of a pulse width modulation of the converter. A pulse width modulation of the converter is a simple way to adjust a value of the impedance of the converter.

An embodiment of the controller is defined by a width of the pulse width modulation of the converter being increased or decreased respectively in case the values of the current signal flowing through the battery arrangement show an increase and being decreased or increased respectively in case the values of the current signal flowing through the battery arrangement show a decrease. This embodiment is easy to realize.

An embodiment of the controller is defined by said controlling comprising said adjustments in case a value of a voltage signal present across the battery arrangement is not larger than a threshold value. In case a value of a voltage signal present across the battery arrangement is larger than a threshold value, a control of the converter may be kept as it is, apart from dependencies on parameters such as battery parameters. Said threshold value may be the boost battery voltage level or the equalisation voltage level.

An embodiment of the controller is defined by the controller comprising a processor or a microprocessor. To convert detections of analog values of a current signal flowing through the battery arrangement into digital values that can be processed by a processor/microprocessor, an analog-to-digital-conversion of the values may be necessary.

According to a second aspect, a converter is provided for converting first power from a solar arrangement into second power for a battery arrangement, the converter comprising a controller as defined above.

According to a third aspect, a solar arrangement is provided comprising the converter as defined above.

According to a fourth aspect, a battery arrangement is provided comprising the converter as defined above.

According to a fifth aspect, a method is provided for controlling a converter configured to convert first power from a solar arrangement into second power for a battery arrangement, said controlling comprising a step of, in response to detections of values of a current signal flowing through the battery arrangement, adjusting an impedance of the converter for maximizing the current signal.

According to a sixth aspect, a computer program product is provided for, when run on a computer, performing the step of the method as defined above.

According to a seventh aspect, a medium is provided for storing and comprising the computer program product as defined above.

An insight is that a voltage signal present across a battery arrangement will be relatively stable. A basic idea is that, in response to detections of values of a current signal flowing through the battery arrangement, an impedance of a converter is to be adjusted to maximize this current signal.

A problem to provide an advantageous controller has been solved. A further advantage is that maximum power point tracking is done faster and more efficiently.

These and other aspects of the invention will be apparent from and elucidated with reference to the embodiments described hereinafter.

### BRIEF DESCRIPTION OF THE DRAWINGS

In the drawings:

FIG. 1 shows a first embodiment of system,

FIG. 2 shows a flow chart,

FIG. 3 shows a second embodiment of a system,

FIG. 4 shows a third embodiment of a system, and

FIG. 5 shows a fourth embodiment of a system.

### DETAILED DESCRIPTION OF EMBODIMENTS

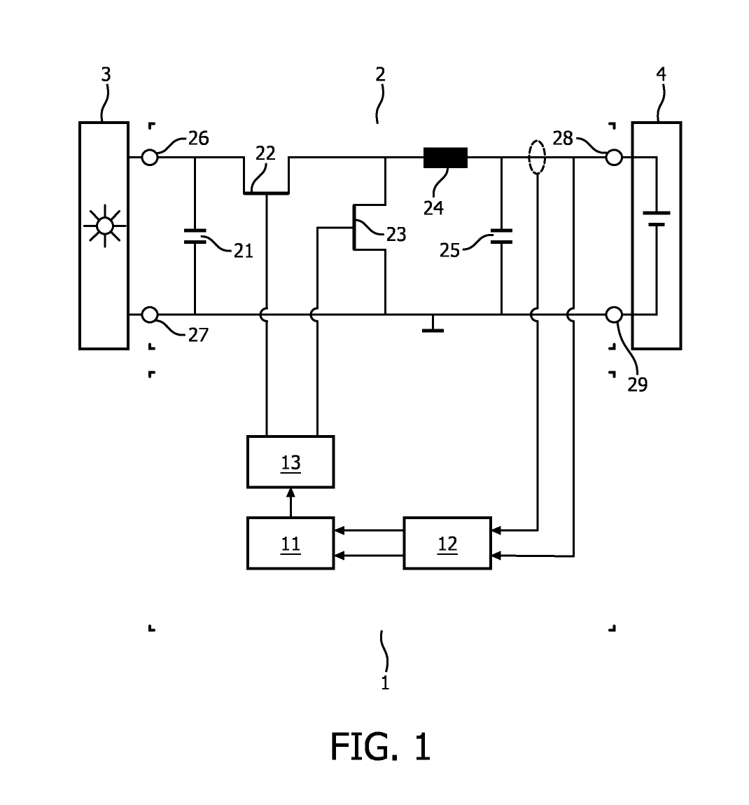

In the FIG. 1, a first embodiment of system is shown. The system comprises a controller 1 for controlling a converter 2 configured to convert first power from a solar arrangement 3 into second power for a battery arrangement 4. Thereto, terminals of the solar arrangement 3 are coupled to first and second terminals 26, 27 of the converter 2, and third and fourth terminals 28, 29 of the converter 2 are coupled to terminals of the battery arrangement 4. The converter 2 comprises an input capacitor 21 coupled to the first and second terminals 26, 27 of the converter 2, and comprises an output capacitor 25 coupled to the third and fourth terminals 28, 29 of the converter 2. The first terminal 26 of the converter 2 is coupled via a first switch 22 such as for example a first transistor and via an inductor 24 to the third terminal 28 of the converter 2. An interconnection between the first switch 22 and the inductor 24 is coupled via a second switch 23 such as for example a second transistor to the second and fourth terminals 27, 29 of the converter 2. Other kinds of converters 2 and other kinds of switches 22, 23 are not to be excluded. Each transistor may comprise one transistor or may comprise two or more transistors of whatever kind and—for two or more—in whatever combination.

The controller 1 comprises for example a processor or a microprocessor 11 with inputs coupled to outputs of an input interface 12 and with outputs coupled to inputs of an output interface 13. Inputs of the input interface 12 are coupled to the third terminal 28 of the converter 2 for detecting values of a voltage signal present across the battery arrangement 4 and for detecting values of a current signal flowing through the battery arrangement 4. Said detections for example comprise measurements of the values of the voltage signal directly and for example comprise measurements of the values of the current signal indirectly by measuring values of voltages present across a (for example relatively small) resistor directly that is serially coupled between the inductor 24 and the third terminal 28 of the converter 2. Other kinds of detections and other kinds of measurements are not to be excluded. Outputs of the output interface 13 are coupled to control inputs of the first and second switches 22, 23.

Said controlling comprises, in response to the detections of the values of the current signal flowing through the battery arrangement 4, adjustments of an impedance of the converter 2 for maximizing the current signal. Preferably, the controller 1 is configured to perform (a kind of) maximum power point tracking without multiplying a voltage signal provided by the solar arrangement 3 and a current signal flowing through the solar arrangement 3. Such multiplications of signals are considered to be disadvantageously complex and time-consuming and should preferably be avoided as much as possible. Further, said controlling may only comprise said adjustments as long as a value of a voltage signal present across the battery arrangement 4 is not larger than a threshold value.

The impedance of the converter 2 is the impedance experienced between the first and third terminals 26, 28, with the second and fourth terminals 27, 29 being connected to ground. A value of this impedance depends on the non-controlled capacitors 21, 25 and on the non-controlled inductor 24 and on the controlled switches 22 and 23 including their controls and their control points.

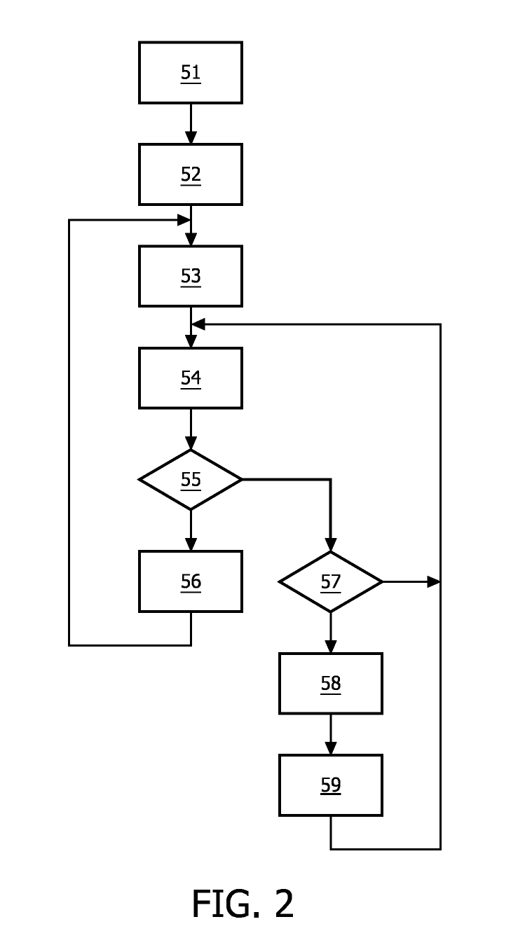

Preferably, as further explained at the hand of the FIG. 2, said adjustments comprise an adjustment in a first direction in case the values of the current signal flowing through the battery arrangement 4 show an increase and comprise an adjustment in a different second direction in case the values of the current signal flowing through the battery arrangement 4 show a decrease. Said adjustments may for example comprise adaptations of a pulse width modulation of the converter 2. A width of the pulse width modulation of the converter 2 may be increased (or decreased) in case the values of the current signal flowing through the battery arrangement 4 show an increase and may be decreased (or increased) in case the values of the current signal flowing through the battery arrangement 4 show a decrease.

The input interface 12 may be left out in case the processor or microprocessor 11 can handle the couplings to the third terminal 28 of the converter 2 directly. The input interface 12 may perform an analog-to-digital-conversion in case the processor or microprocessor 11 is configured to receive digital information. Alternatively the input interface 12 may form part of the processor or microprocessor 11. The processor or microprocessor 11 is an example only and other kinds of controllers 1 are not to be excluded. The output interface 13 may be left out in case the processor or microprocessor 11 can control the first and second switches 22, 23 directly. The output interface 13 may perform a digital-information-to-pulse-width-modulation-information-conversion in case the processor or microprocessor 11 is configured to provide digital information different from pulse width modulation information. Alternatively the output interface 13 may form part of the processor or microprocessor 11.

In the FIG. 2, a flow chart is shown, wherein the following blocks have the following meaning:
Block 51: Start, set a default value for a pulse width modulation for the converter 2.
Block 52: Detect a value of a current signal flowing through the battery arrangement 4 and store it as a storage value.
Block 53: Increase the value of the pulse width modulation by a first step value. A size of the first step value may be the same all the time of may depend upon one or more situations such as for example a value of the current signal flowing through the battery arrangement 4 and/or a moment in time and/or an available amount of processor capacity etc.
Block 54: Detect a new value of a current signal flowing through the battery arrangement 4.
Block 55: Compare the storage value and the new value, if the new value is larger than the storage value and if a value of a voltage signal present across the battery arrangement 4 is not larger than a threshold value, go to block 56, otherwise go to block 57.
Block 56: Replace the storage value by the new value and store it as the storage value. Then go to block 53.
Block 57: Compare the storage value and the new value, if the new value is smaller than the storage value and if a value of a voltage signal present across the battery arrangement 4 is not larger than a threshold value, go to block 58, otherwise go to block 54.
Block 58: Replace the storage value by the new value and store it as the storage value.
Block 59: Decrease the value of the pulse width modulation by a second step value. A size of the second step value may be the same all the time of may depend upon one or more situations such as for example a value of the current signal flowing through the battery arrangement 4 and/or a moment in time and/or an available amount of processor capacity etc. and may be equal to or different from the size of the first step value. Then go to block 54.

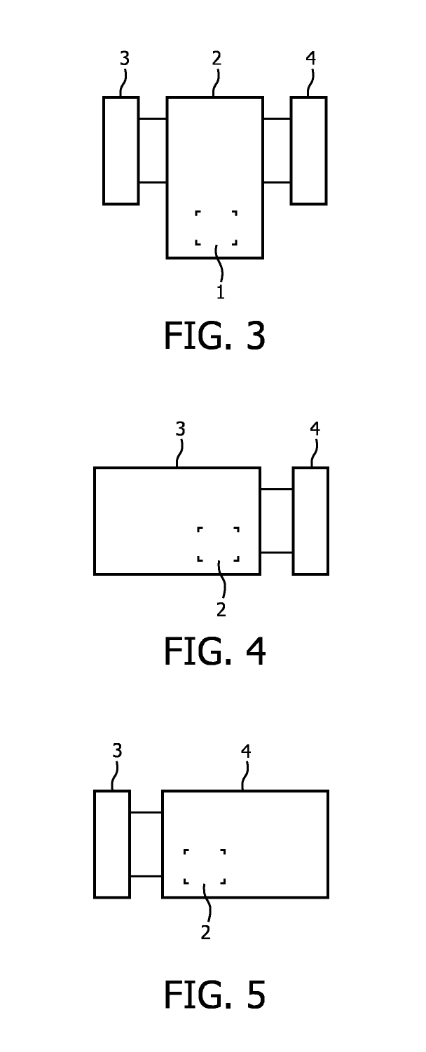

In the FIG. 3, a second embodiment of a system is shown, wherein the converter 2 comprises the controller 1.

In the FIG. 4, a third embodiment of a system is shown, wherein the solar arrangement 3 comprises the converter 2, and wherein the converter 2 comprises the controller 1 not shown here.

In the FIG. 5, a fourth embodiment of a system is shown, wherein the battery arrangement 4 comprises the converter 2, and wherein the converter 2 comprises the controller 1 not shown here.

Summarizing, controllers 1 control converters 2 that convert first power from solar arrangements 3 into second power for battery arrangements 4. Said control comprises, in response to detections of values of current signals flowing through the battery arrangements 4, adjustments of impedances of the converters 2 for maximizing the current signals. A kind of maximum power point tracking is performed, without many multiplications of voltage signals and current signals provided by the solar arrangements 3 needing to be performed. Said adjustments may comprise adjustments in first directions in case the values of the current signals flowing through the battery arrangements 4 show increases and adjustments in different second directions in case the values of the current signals flowing through the battery arrangements 4 show decreases. Said adjustments may comprise adaptations of pulse width modulations of the converters 2.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A controller for controlling a converter configured to convert first power from a solar arrangement into second power for a battery arrangement, said controlling comprising, in response to detections of only values of a current signal flowing through the battery arrangement, perform maximum power point tracking via adjustments of an impedance of the converter for maximizing the current signal.

2. The controller as defined in claim 1, the controller being configured to perform maximum power point tracking without multiplying a voltage signal provided by the solar arrangement and a current signal flowing through the solar arrangement.

3. The controller as defined in claim 1, said adjustments comprising an adjustment in a first direction in case the values of the current signal flowing through the battery arrangement show an increase and comprising an adjustment in a second direction in case the values of the current signal flowing through the battery arrangement show a decrease, said first and second directions being different directions

4. (canceled)

5. The controller as defined in claim 1, said adjustments comprising adaptations of a pulse width modulation of the converter.

6. The controller as defined in claim 5, a width of the pulse width modulation of the converter being increased or decreased respectively in case the values of the current signal flowing through the battery arrangement show an increase and being decreased or increased respectively in case the values of the current signal flowing through the battery arrangement show a decrease.

7. The controller as defined in claim 1, said controlling only comprising said adjustments in case a value of a voltage signal present across the battery arrangement is not larger than a threshold value.

8. The controller as defined in claim 1, the controller comprising a processor or a microprocessor.

9. A converter for converting first power from a solar arrangement into second power for a battery arrangement, the converter comprising a controller as defined in claim 1.

10. A solar arrangement comprising the converter as defined in claim 9.

11. A battery arrangement comprising the converter as defined in claim 9.

12. A method for controlling a converter configured to convert first power from a solar arrangement into second power for a battery arrangement, said controlling comprising a step of, in response to detections of only values of a current signal flowing through the battery arrangement, perform maximum power point tracking via adjusting an impedance of the converter for maximizing the current signal.

13. A computer program product for, when run on a computer, performing the step of the method as defined in claim 12.

14. A medium for storing and comprising the computer program product as defined in claim 13.
